(19) United States
(12) Patent Application Publication
(10) Pub. No.: US 2009/0243559 A1
(43) Pub. Date: Oct. 1, 2009

(54) UNIVERSAL, FAIL-SAFE, COMMON CONTROL OF MULTIPLE ALTERNATORS ELECTRICALLY CONNECTED IN TANDEM PARALLEL FOR PRODUCING HIGH CURRENT

(76) Inventors: Luis E. Bartol, Mexico (MX); Muriel L. Bartol, Los Angeles, CA (US)

Correspondence Address: William C. Fuess;Attorney at Law, Suite II-G, 10951 Sorrento Valley Road, San Diego, CA, 92121, US

(21) Appl. No.: 12/315,762

(22) Filed: Dec. 5, 2008

Related U.S. Application Data
(63) Continuation-in-part of application No. 12/079,273, filed on Mar. 25, 2008.

(51) Int. Cl. G05F 1/10

(52) U.S. Cl. 322/15

(57) ABSTRACT

Two or more alternators—each typically of an economical cost and of any mixture of types and capacities—are turned by a single power source—normally the engine of a large commercial truck or bus burning fuel so as to produce minimum emissions and thus operating at such higher combustion temperature as does raises the ambient temperature of the engine compartment to 125° Celsius. The several alternators are electrically connected in tandem-parallel across a battery/load. A corresponding number of identical electronic voltage regulators, preferably of the type described in U.S. Pat. No. 5,723,972 modified according to the present invention, respectively individually control the alternators. One electronic voltage regulators externally programmed to become a designated “master” produces a “universal” control signal in response to variations in a voltage across the battery/load. This “universal” control signal is used (1) in the “master” electronic voltage regulator itself to provide regulation to an associated alternator, and is wired to all other voltage regulators externally programmed as “followers” to (2) produce in each of these voltage regulators produces a signal for the regulation control of its associated alternator not by reference to the battery/load voltage (as would be normal), but rather by reference to the “universal” control signal.

### REFERENCE TO RELATED PATENT APPLICATIONS AND PATENTS

The present patent application is related to co-pending U.S. patent application Ser. No. 12/079,273 filed Mar. 29, 2008, for a PULSE-POSITION-MODULATED VEHICULAR ALTRERNATOR VOLTAGE REGULATOR WITH DUAL AC-FEEDBACK NETWORKS, CONTROLLED “OFF” PERIOD, AND LOW INSERTED ELECTRICAL NOISE to the same Luis E. Bartol who is a co-inventor of the present invention; and is further related to U.S. Pat. No. 5,723,972 issued Mar. 3, 1998 for FAIL-SAFE COMMON CONTROL OF MULTIPLE ALTERNATORS ELECTRICALLY CONNECTED IN TANDEM PARALLEL FOR PRODUCING HIGH CURRENT to co-inventors Luis E. Bartol and German Holguin of whom Luis E. Bartol is a co-inventor of the present invention.

This related patent and patent application are in turn related to U.S. Pat. No. 6,677,739 for a HIGH-RELIABILITY, LOW-COST, PULSE-WIDTH-MODULATED VEHICULAR ALTERNATOR VOLTAGE REGULATOR WITH SHORT-CIRCUIT PROTECTION AND LOW INSERTED ELECTRICAL NOISE to the selfsame Luis E. Bartol and Muriel Bartol who are co-inventors of the present invention; to U.S. Pat. No. 5,744,941 issued Apr. 28, 1998 for a SINGLE-WIRE-CONNECTED HIGH-SENSITIVITY DUAL-MODE A.C./D.C.TURN-ON/TURN-OFF STAGE FOR AN ELECTRONIC VOLTAGE REGULATOR issued to Luis E. Bartol and German Holguin; and to U.S. Pat. No. 5,325,044 issued Jun. 28, 1994 for an ELECTRONIC VOLTAGE REGULATOR PROTECTED AGAINST FAILURE DUE TO OVERLOAD, OR DUE TO LOSS OF A REFERENCE VOLTAGE to Luis E. Bartol. The contents of the related predecessor patent application and patents are incorporated herein by reference.

### BACKGROUND OF THE INVENTION

1. Field of the Invention

The present invention generally concerns improvements to voltage regulators in general, and in particular concerns improvements to vehicular electronic voltage regulators used in heavy duty, high current, high performance applications. Because the main design intent of the present invention is concerned with high reliability service in heavy duty applications, the improvements of the present invention are particularly useful for (i) revenue-generating vehicles such as trucks and buses, and (ii) emergency vehicles such as ambulances and fire trucks.

2. Description of Prior Art

FIGS. 1, 2 and 3 are prior art embodiments of the present invention related to U.S. Pat. No. 5,723,972, where FIG. 1 is a block diagram showing the prior art embodiment of a number of alternator-regulator pairs interconnected in electrical parallel to produce higher current. FIG. 2 is a prior art preferred embodiment of a “Master Voltage Regulator”, and FIG. 3 is a prior art preferred embodiment of an exemplary “Follower Voltage Regulator” from this patent. Over the, years, thousands of Master and Follower voltage regulators built in accordance with the teachings of U.S. Pat. No. 5,723,972 have been sold in the United States of America as integral parts of corresponding prior art, heavy duty, alternators of high current capacity under the registered trademark “TwinPower”. (“Twin Power” is the subject of United States trademark registration number 2866068 to registrant Industrias Condor, S.A. de C.V. CORPORATION MEXICO Blvd. M. Cervantes Saavedra No. 17, Col. Granada Mexico City, D.F. MEXICO 11520.) The application for these systems has generally been for emergency vehicles such as fire trucks.

With the progressive introduction of low-emission internal combustion engines to comply with the pertinent United States Federal Legislation circa mid-2004, combustion temperatures in commercial engines have been progressively raised, resulting in higher ambient temperatures in the engine compartment where the alternator-regulator pairs are generally mounted. Up to and including circa late 2006, ambient temperatures attained in these engine compartments were generally a maximum of 110 degrees Celsius. However, from this point forward engine ambient temperatures have been raised still further and are now, circa the end of 2008, generally approaching 125 degrees Celsius.

Moreover, (1) the number and type of electrical appliances deriving power from the vehicle's electrical system has continued to increase, while (2) ever more ubiquitous computer-controlled subsystems require a relatively less noisy electrical power system for proper performance. Still further, some of these above-mentioned appliances have at times and of themselves generated sufficient electrical noise into the electrical generating system so as to destabilize the previous “Master” and “Follower” voltage regulators and to cause instability in the vehicle's electrical power generating system.

Finally, some customers have been requesting that a single, field-programmable, Master/Follower voltage regulator be supplied rather than the distinct single “Master” and any of several possible “Follower” voltage regulators in order to simplify stocking of parts and provision of repair service to the end-customer.

It is clear from the above discussion that an improved, single, Master/Follower voltage regulator, (1) able to operate continuously at temperatures of 125 degrees Celsius, (2) modified to introduce a low level of electrical noise into the electrical generating system and (3) further modified to operate reliably in a noisy electrical environment, would be a desirable, “Universal”, device able to perform under the most extreme operating conditions.

### SUMMARY OF THE INVENTION

The present invention, which has been filly and thoroughly tested by its inventors, is directed to improvements in the proven, high reliability Frequency-On-Demand voltage regulators such as are taught in U.S. Pat. No. 5,723,972. These improvements are directed to eliminating certain unresolved problem issues associated with this design, namely (1) voltage/current fluctuations both at no-load and near full-load (known in the trade as “jitter”), (2) abrupt transitions in the ON-OFF-ON cycles that result in induced electrical noise, (3) unstable operation caused by electrical appliances which generate high electrical noise, (4) unstable operation caused by high ambient operating temperatures and (5) the manufacture and use of two distinct regulator designs—“Master” and “Follower”. In accordance with the present invention a single, “Universal”, voltage regulator design that can be externally programmed to become either a “master” or a “follower” voltage regulator for use with multiple alternators electrically connected in tandem parallel.

Moreover, modifications made to the voltage regulator design realize the following objectives. First, an additional amplification stage using a complementary transistor amplifier is introduced in the voltage detector stage of the original master regulator design. This configuration permits the use of a positive AC feedback loop between the complementary transistor amplifiers, which AC feedback loop results in a synchronization signal with sharply defined rise and fall transitions rather than the undulating analog waveform that is typical of the prior art. This particular technique—related to a technique taught in U.S. application Ser. No. 12/079273 but not for a synchronization signal between multiple voltage regulators as control multiple alternators—results in a much higher signal-to-noise ratio for the synchronization signal, which synchronization signal then becomes generally immune to externally-produced electrical noise.

Second, the “ON” and “OFF” transitions of the alternator control signal are rounded off as taught in U.S. Pat. No. 6,667,739 in order to reduce inserted electrical noise.

Third, the original master regulator is provided with both a “synchronization signal” output (“Sync Source”) and a “synchronization signal” input (“Synch Bus”) which permit, in combination, external programming with a simple jumper. Namely, a (1) “Master” voltage regulator is realized by a jumper wire between the “Sync Source” and the “Synch Bus”, while (2) a “Follower” voltage regulator is realized when the “Synch Bus” input, only, is connected to a common synchronizing line.

These aspects of the present invention, and others, will become better understood upon reference to the following drawings and accompanying specification.

### BRIEF DESCRIPTION OF THE DRAWINGS

FIG. 1 is a block diagram of a prior art tandem-parallel-connected multiple alternator electrical system that supplies current to a common battery (or battery bank) and a common load, where each (prior art) alternator is controlled by an associated prior art voltage regulator—one of which voltage regulators is a master serving to control by wired connection all others as followers.

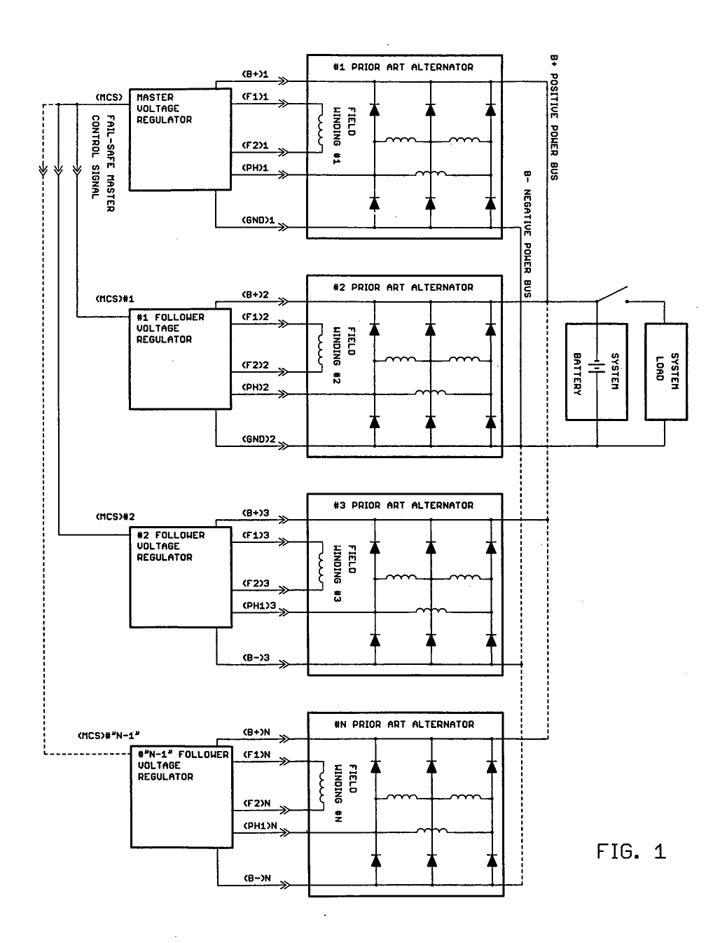

FIG. 2 is the schematic diagram of a prior art master voltage regulator.

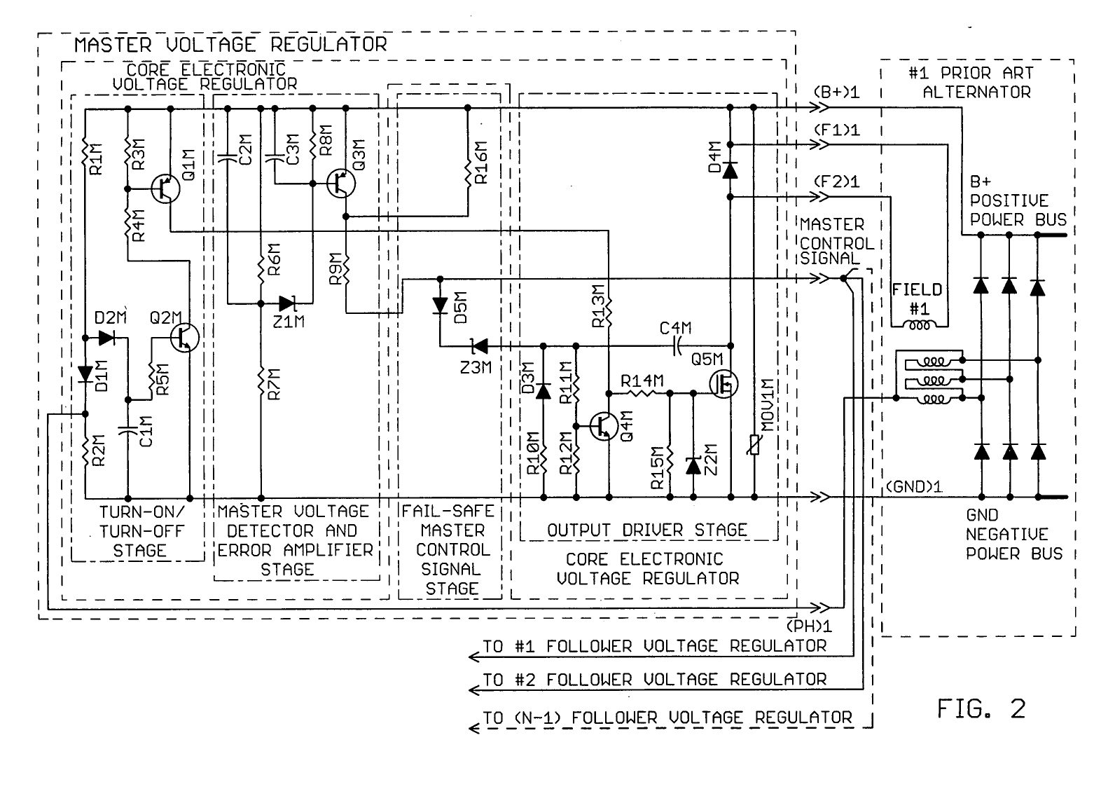

FIG. 3 is the schematic diagram of a prior art follower voltage regulator.

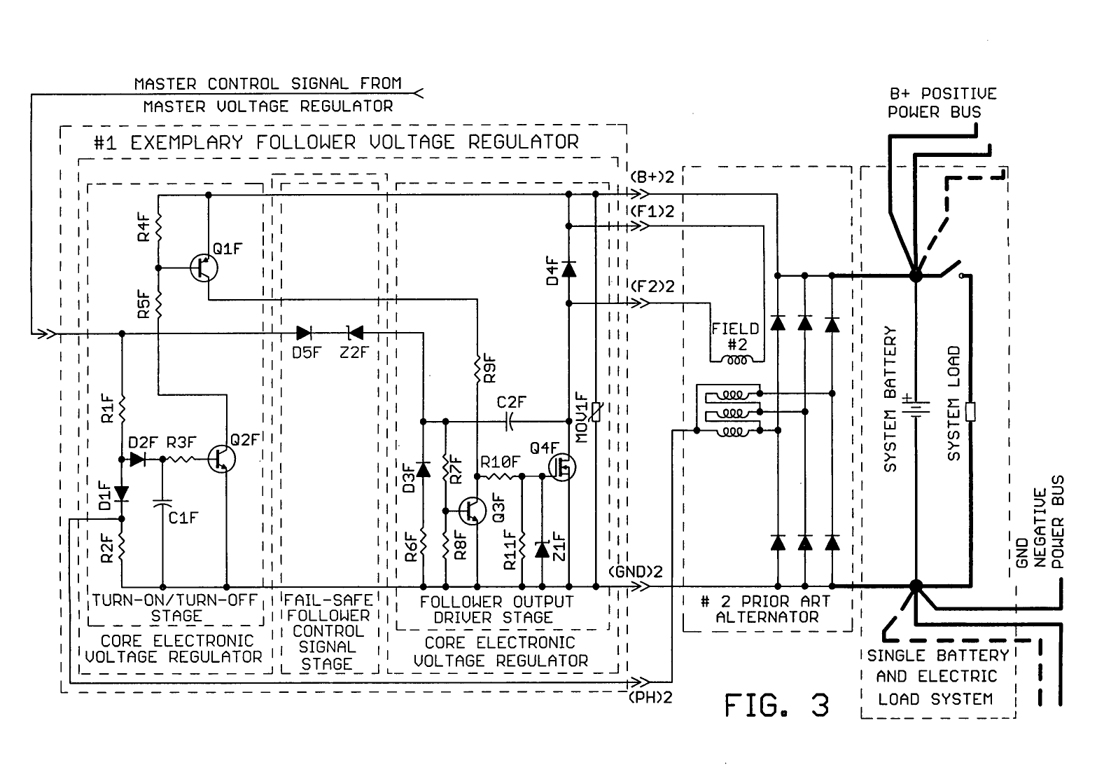

FIG. 4 is a block diagram of a tandem-parallel-connected multiple alternator electrical system in accordance with the present invention that supplies current to a common battery (or battery bank) and a common load, and where each alternator is controlled by an associated voltage regulator, now where all of the voltage regulators are of identical construction with one of externally programmed (by a jumper connection) to become a master, controlling by wired connection all others as followers.

FIG. 5 is a schematic diagram of a first preferred embodiment of a “universal” voltage regulator in accordance with the present invention that can be externally programmed (with a jumper connection) to become a master voltage regulator.

FIG. 6 is a schematic diagram of a second preferred embodiment of a “universal” voltage regulator in accordance with the present invention that can be externally programmed (with a jumper connection) to become a master voltage regulator.

FIG. 7 is a block diagram of the present invention illustrating a special case where all the electronic voltage regulators controlling corresponding (prior art) alternators are programmed as master voltage regulators.

### DESCRIPTION OF THE PREFERRED EMBODIMENT

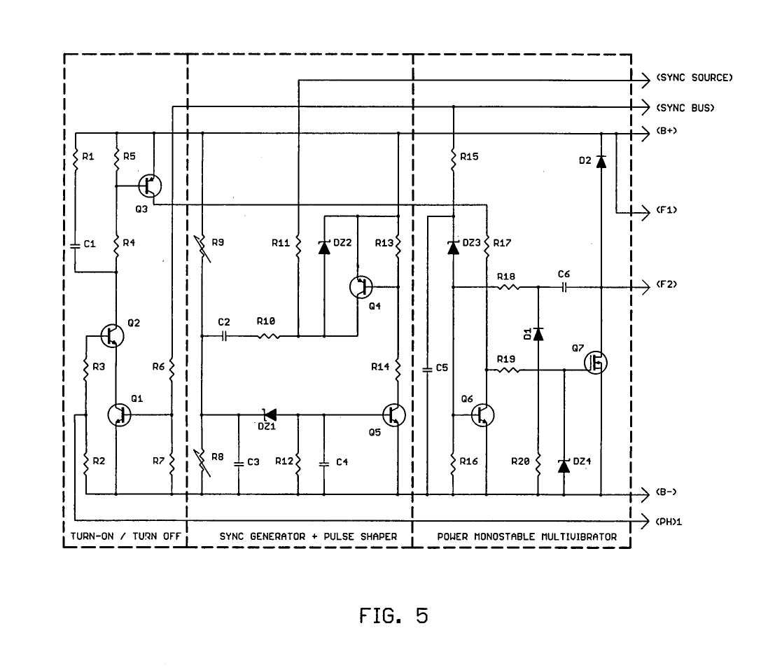

A functional description of a preferred first, “universal”, fail-safe, embodiment of the present invention, shown in schematic diagram in FIG. 5, is as follows:

FIG. 5 is a schematic diagram of a preferred first embodiment of an “A”-type voltage regulator built according to the teachings of related U.S. Pat. No. 5,723,972—which patent is in turn is related to patent application Ser. No. 12/079273 and to U.S. Pat. Nos. 5,325,044, 5,744,941 and 6,667,739.

In FIG. 5 an NPN-type amplifier composed of R9, R8, C3, DZ1, R12, C4 and Q5 drives a PNP-type amplifier composed of R11, Q4, R13 and R14. Positive feedback network C2, R10, feeds back the output of the PNP amplifier to the input of the NPN amplifier and produces a rectangular pulse train having sharply-defined rise and fall signal wave fronts across the output load resistor R11, which rectangular pulse train is the output of the regulator's voltage detector stage identified as “Synch Generator & Pulse Shaper” in FIG. 5. This pulse train is directly related to the error signal generated by the Frequency-on Demand voltage regulator design of the present invention that serves—when coupled to the output power stage of the selfsame voltage regulator that is identified as a “Power Monostable Multivibrator” in FIG. 5 and composed of R15, DZ3, C5, R16, Q6, R17, R18, R19, R20, D1, C6, DZ4, D2 and Q7—to produce the regulating voltage pulses across the field winding of the (prior art) alternator to which the voltage regulator is connected. Thus is voltage regulation of the alternator output realized.

Continuing in FIG. 5, a coupling of output load resistor R11 to the input of the “Power Monostable Multivibrator” stage of the voltage regulator takes place when the “Sync Source” terminal is connected to the “Sync Bus” terminal through a simple jumper—externally available in the vehicle's wiring harness. Thus, when an external jumper connection between the “Sync Source” and “Sync Bus” terminals is completed, the voltage regulator of the present invention is enabled to regulate the voltage output of the alternator to which it is connected. The regulator thus enabled, becomes a “Master” regulator, as such term is used in related U.S. Pat. No. 5,723,972. This “Master” voltage regulator is able to control not only the alternator to which it is connected, but also all other tandem-parallel connected alternators through their associated voltage regulators, by the simple expedient of wire-connecting the “Sync Source”—“Sync Bus” node of the “Master” regulator to the “Sync Bus” terminal of all other, identical, regulators in the electrical generating system, thus forcing all these other regulators to become “Follower” voltage regulators.

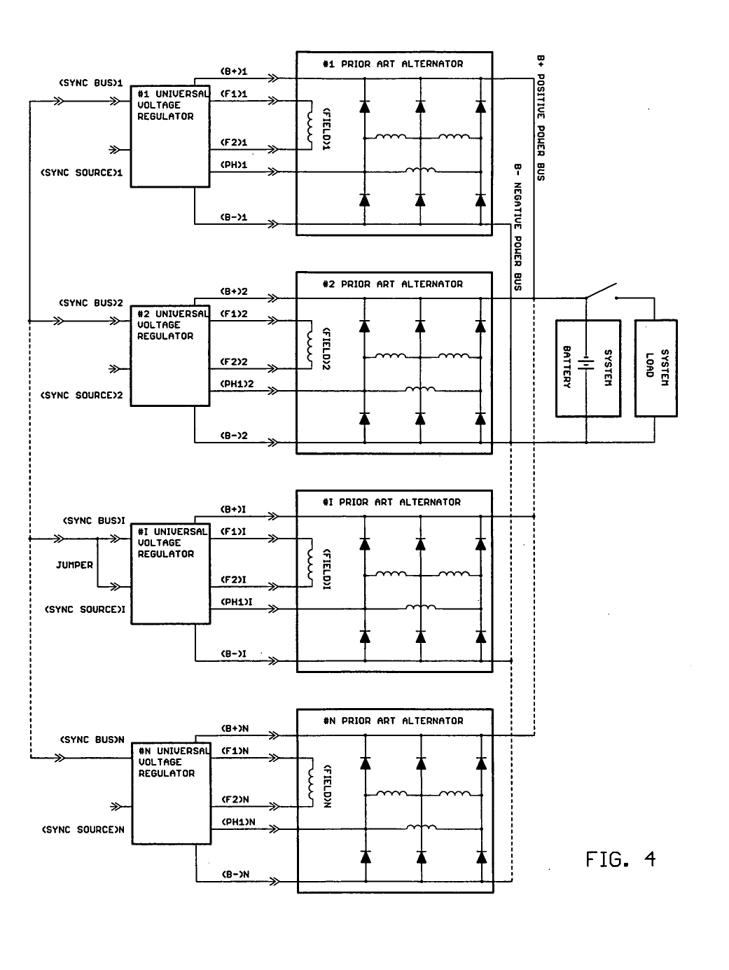

See this in FIG. 4, which is a block diagram showing a tandem-parallel connected alternator-regulator generating system in accordance with the present invention. FIG. 4 shows single regulator “#I Universal Voltage Regulator” externally programmed through a simple jumper connection to become a designated “Master” voltage regulator, thereafter controlling by wired connection all other, identical, voltage regulators as “Follower” voltage regulators.

Continuing in FIG. 5, the synchronization signal available at the “Sync Source”—“Sync Bus” node of the master voltage regulator is a rectangular waveform with sharply-defined transitions. This strong signal produced by transistors Q2 and Q1 serves to make the generating system essentially immune to external electrical noise as is taught in co-pending U.S. application Ser. No. 12/079273. In particular, the positive feedback network C2-R10 (1) eliminates the voltage/current fluctuations associated with the Frequency-on-Demand regulator of the present invention; (2) provides the regulator with an internal timing reference that makes the master regulator exceptionally stable and independent of external variables such as alternator field inductances; and (3) results in a high-stability regulating system capable of operating reliably at the high temperatures required by modern low-emission internal combustion engines.

Continuing in FIG. 5, zener diode DZ2 is used to further improve the noise-rejection characteristic of the voltage detector stage by forcing transistor Q4 into deeper conduction to overcome the fixed zener voltage barrier. The added amplification of the NPN amplifier in the voltage detector stage, renders a low impedance at the output of the PNP amplifier stage and permits this PNP amplifier stage to drive a large number of follower alternator-regulator pairs—hence, the cumulative power output of a typical electrical generating system built according to the present invention is limited only by the space constraints of the vehicle in which the system is installed.

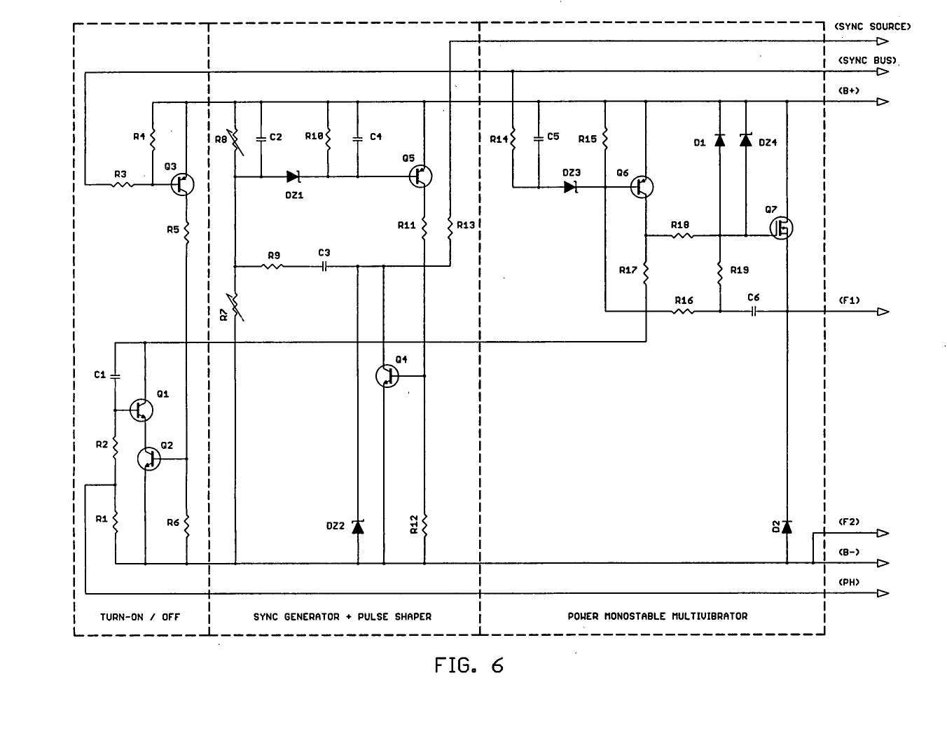

As taught in U.S. Pat. No. 6,677,739, the resistance values of resistors R17 and R19 is chosen so the regulators of the present invention introduce a minimum of electrical noise into the system. The “Turn-On/Turn-Off” stage of the present invention was modified as shown in FIG. 6 with respect to the corresponding stage of the prior art master and follower regulators to reliably turn-off said regulators at 125° Celsius.

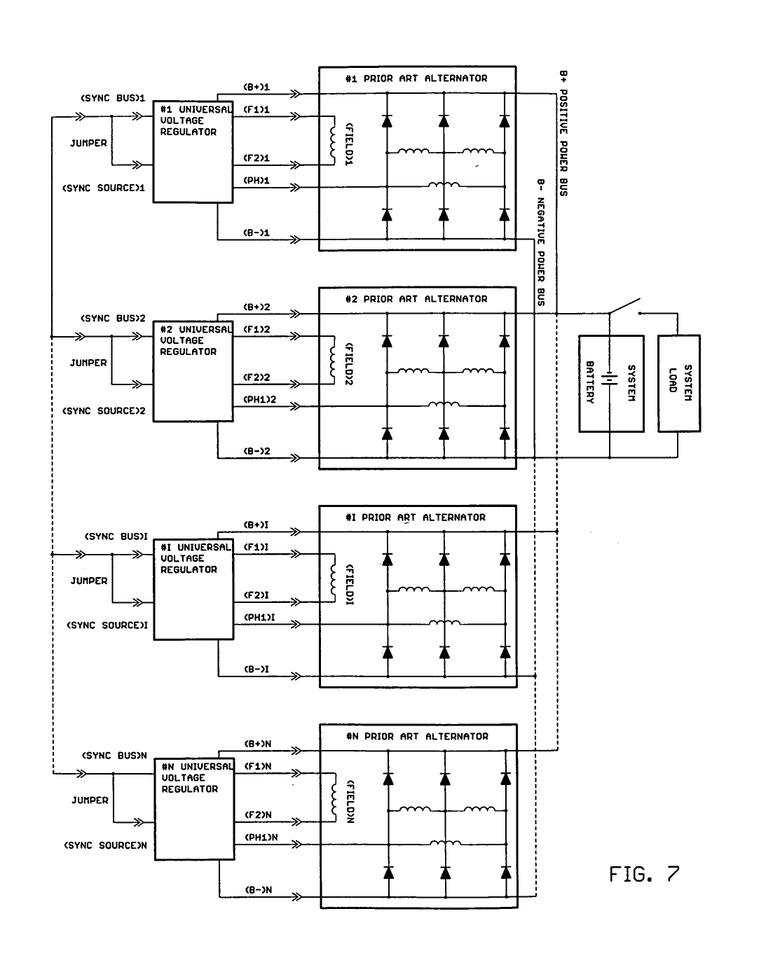

FIG. 7 is a block diagram of a tandem-parallel connected alternator-regulator generating system of the present invention where all the identical regulators are programmed as “Masters”. This connection is an illustration of the possibilities available when all regulators are both (1) identical in construction and (2) externally (or internally) programmable as masters. A natural hierarchy controls the functioning of this connection: First, the regulator with the lowest voltage target will control all others. Second, the regulator with the longest “OFF-time” will control all others.

This is a fairly obvious result of the way the voltage regulators are interconnected when (1) the “OFF” time output from the voltage detector stage propagates to all other regulators through the “Sync Source”/Sync Bus” node, while (2) the “ON” time will invariably start simultaneously in all regulators because the power output multivibrator stages of all voltage regulators will have spent their natural periods long before the extinction of the predominant “OFF” period.

The importance of the all-master-connected regulator-alternator system is that a single wire will suffice to synchronize all regulator-alternator pairs. Caution must be exercised with this connection: In case the single wire connection to any regulator (“Sync Source/Sync Bus” node) should become broken, then the regulator with the broken wire connection will revert to its own, internal, reference voltage regulation target rather than the predominant voltage target of the still connected regulators. If this single regulator with the broken synchronization cable has a higher target voltage than the predominant target voltage of the still wire-connected voltage regulators, then the former will tend to regulate its associated alternator to a higher voltage and will thus contribute much more current to the common power bus than the remaining alternators, which can cause a premature failure in the alternator controlled by the regulator with the open connection to the “Sync Source/Sync Bus” node

In the discussion so far regarding the functioning of the present invention, no mention has been made to the fail-safe mode of operation, which is of fundamental importance to the usefulness of the voltage regulators of the present invention. The related U.S. Pat. No. 5,723,972 thoroughly covers this aspect of the voltage regulators, and the various voltage regulator embodiments of the present invention will be recognized to fully incorporate the fail-safe features taught in this related Patent.

Further in the preceding discussion, only an “A-type” embodiment of the present invention, incorporating an N-channel Metal Oxide Semiconductor (MOS) power transistor, has been described. A second, preferred embodiment of the present invention as a “B-type” voltage regulator (one end of the alternator field connected to “B-”) incorporating a P-Channel MOS power transistor is shown in FIG. 6. A practitioner of the voltage regulator design, and electrical engineering, art will recognize that the functional description of this second preferred embodiment shown in FIG. 6 is identical to the one used for the first preferred embodiment shown in FIG. 5.

In summary, there has thus been seen a system where two or more alternators—each typically of an economical cost and of any mixture of types and capacities—are turned by a single power source—normally the engine of a large commercial truck or bus. This engine is modified to burn its fuel so that it produces a minimum of emissions in accordance with presently mandated U.S. Federal Legislation, circa late 2008. As a result the engine operates at a higher combustion temperature, which raises the ambient temperature of the engine compartment up to a present 125° Celsius.

Several alternators within this engine compartment are electrically connected in tandem-parallel across a battery/load. A corresponding number of identical electronic voltage regulators, preferably of the type described in U.S. Pat. No. 5,723,972 modified according to the present invention, respectively individually control the alternators. One of these identical electronic voltage regulators is externally programmed to become a designated “master”, producing a “universal” control signal in response to variations in a voltage across the battery/load. This “universal” control signal is further used in the “master” electronic voltage regulator itself to develop a conventional signal providing regulation to an associated alternator. It is also provided by wired connection to all remaining, identical, voltage regulators, each of which is externally programmed to become a “follower” voltage regulator. Each of these “follower” voltage regulators produces a signal for the regulation control of its associated alternator not by reference to the battery/load voltage (as would be normal), but rather by reference to the reference control signal.

This universal control signal is developed in circuitry carefully designed so as to render a rectangular wave shape with sharply defined rise and fall transitions, permitting the electrical system to operate reliably even with high levels of externally-induced electrical noise. Failure malfunctions of one only alternator, or voltage regulator, do not cause either outage or runaway of the entire system, but instead only cause either reduced power generation capacity in the system or runaway in only one of the alternators. Generating capacity of a system thus constructed is limited only by the space constraints of the vehicle in which the system is installed.

In accordance with the preceding explanations and the two embodiments within which the present invention has been shown, the invention should be interpreted broadly, in accordance with the following claims only, and not solely with those particular embodiments within which the invention has been taught.

What is claimed is:

1. A power system for producing electrical power from a source of motive power comprising:
a battery;
a plurality of alternators connected in electrical parallel across the battery, each alternator being individually responsive to an individually associated regulating signal to produce electrical power from the source of motive power; and
a plurality of electronic voltage regulators including
a electronic voltage regulator made master by an external jumper wire, producing a control signal in response to variations in a voltage across the battery, and providing in response to this control signal a regulating signal to an associated one of the plurality of alternators, and
at least one voltage regulator made follower by an external jumper wire, receiving the control signal, for providing in response to this control signal a regulating signal to an individually associated one of the plurality of alternators.

2. The power system according to claim 1 suitable for use on a vehicle wherein the battery comprises:
a vehicular battery;
wherein the plurality of alternators comprise:
vehicular alternators;
and wherein the plurality of electronic voltage regulators comprise:
vehicular electronic voltage regulators.

3. The power system according to claim 1 wherein each of the plurality of voltage regulators is a Frequency-on-Demand voltage regulator producing an associated pulse-position-modulated regulating signal.

4. The power system according to claim 3 wherein the producing of the pulse-position-modulated regulating signal by a voltage regulator is stable for ambient operating temperatures of the voltage regulator as high as 125 degrees Celsius.

5. The power system according to claim 1 wherein the at least one follower voltage regulator of the plurality of voltage regulators comprises:
a circuit protecting the at least one follower voltage regulator of the plurality of voltage regulators against induced failure due to loss of the control signal from the master voltage regulator.

6. The power system according to claim 1 that is fail-safe against outage in that failure in any one of the plurality of alternators, which failure causes an outage wherein no associated electrical power is produced, is insufficient to cause an outage of the entire power system, the power system suffering only a reduced overall power generation capacity.

7. The power system according to claim 1 that is fail-safe against outage in that failure in any one electronic voltage regulator or any one alternator of the combined pluralities of both alternators and of electronic voltage regulators, which failure causes an outage wherein no electrical power is produced by an alternator of a voltage-regulator-and-alternator pair whereat failure has occurred, is insufficient to cause an outage of the entire power system, the power system suffering only a reduced overall power generation capacity.

8. The power system according to claim 1 that is fail-safe against runaway in that failure in any one of the plurality of alternators, which failure causes a runaway wherein maximum electrical power is produced by failed alternator regardless of conditions, is insufficient to cause a runaway of the entire power system, the entire power system suffering runaway only in the electrical power produced by the failed one, only, of its plurality of alternators and not by all other ones of its plurality of alternators.

9. The power system according to claim 1 that is fail-safe against runaway in that failure in any one of the plurality of electronic voltage regulators, which failure causes a runaway wherein maximum electrical power is produced by the alternator associated with the failed electronic voltage regulator regardless of conditions, is insufficient to cause a runaway of the entire power system, the entire power system suffering runaway only in the electrical power produced by the one, only, of its plurality of alternators that is associated with the failed electronic voltage regulator, and not by all other ones of its plurality of alternators.

10. The power system according to claim 1 that is fail-safe against runaway in that failure in any one electronic voltage regulator or any one alternator of the combined pluralities of both alternators and of electronic voltage regulators, which failure causes a runaway wherein maximum electrical power is produced by one of the plurality of alternators regardless of conditions, is insufficient to cause a runaway of the entire power system, the entire power system suffering runaway only in the electrical power produced by one only of its plurality of alternators, and not by all other ones of its plurality of alternators.

11. The power system according to claim 1 that is fail-safe against both (i) outage and (ii) runaway in that failure in any one of the combined pluralities of alternators and of electronic voltage regulators, which failure causes either (i) an outage wherein no electrical power is produced by an associated voltage regulator and alternator pair, or else (ii) a runaway wherein maximum associated electrical power is produced by an associated voltage regulator and alternator pair regardless of conditions, is insufficient to, respectively, cause either (i) an outage, or else (ii) a runaway, of the entire power system, the power system suffering, respectively, either only (i) reduced power generation capacity in the overall system, or (ii) runaway in one only of its plurality of alternators.

12. The power system according to claim 1 that is fail-safe against standstill of any one of the plurality of alternators, which standstill is commonly associated with lack of motive drive of the alternator, the entire power system suffering in the event of such standstill only a reduced overall power generation capacity.

13. A method of operating a plurality of electrical alternators to collectively produce more electrical power than would one alternator, the method comprising:
first electrically connecting the plurality of electrical alternators in parallel across a load;
in a one of a corresponding plurality of voltage regulators made “master” by action of an external jumper wire, (1) sensing the voltage appearing across the load, and (2) producing, in response to the sensed voltage, a “master” control signal, and (3) electronically first-regulating, in response to the “master” control signal an associated first one of the plurality of electrical alternators;
responsively to this first-regulating, first-generating in the associated first one of the plurality of electrical alternators electrical power into the load; while
in all others of the plurality of voltage regulators made “follower(s)” by action of an external jumper wire, (4) electronically second-regulating, in response to receipt of the master control signal, an associated one of the remaining plurality of electrical alternators; and
responsively to this second-regulating, second-generating in each associated remaining one(s) of the plurality of electrical alternators electrical power into the load;
wherein the combined electronic first-regulating of a first one of the plurality of electrical alternators, and electronic second-regulating of remaining one(s) of the plurality of electrical alternators, is so as to cause that each of the first-generating and the second-generating is in accordance with individual capacities of the first, and of the second, ones of the plurality of electrical alternators.

14. The method according to claim 13 wherein the first electronically regulating is fail-safe in respect of at least one of
the first-generating, meaning that the electronic first-regulating continues even should, by failure or by lack of motive drive or otherwise, the first one of the plurality of electrical alternators fail to produce electrical power into the load; and
the second-generating, meaning that the electronic second-regulating continues even should, by failure or otherwise, the follower electronic voltage regulator fail in its second electronically regulating of the associated second one of the plurality of electrical alternators.

15. The method according to claim 14 wherein electronic first-regulating is fail-safe in respect of each of the first-generating, the electronic second-regulating, and the second-generating.

16. The method according to claim 13 wherein the first generating is fail-safe in respect of at least one of
the electronic second-regulating, meaning that the first-generating continues even should, by failure or otherwise, the follower electronic voltage regulator fail in its electronic second-regulating of the associated second one of the plurality of electrical alternators, and
the second-generating, meaning that the first generating continues even should, by failure or by lack of motive drive or otherwise, the second one of the plurality of electrical alternators fail to produce electrical power into the load.

17. The method according to claim 16 wherein the first-generating is fail-safe in respect of each of the electronic second-regulating and the second-generating.

18. The method according to claim 13 wherein the electronic second-regulating is fail-safe in respect of at least one of
the electronic first-regulating, meaning that the electronic second-regulating continues even should, by failure or otherwise, the master electronic voltage regulator fail in its electronic first-regulating of the associated first one of the plurality of electrical alternators, and
the first-generating, meaning that the electronic second-regulating continues even should, by failure or by lack of motive drive or otherwise, the first one of the plurality of electrical alternators fail to produce electrical power into the load,
the second-generating, meaning that the electronic second-regulating continues even should, by failure or by lack of motive drive or otherwise, the second one of the plurality of electrical alternators fail to produce electrical power into the load.

19. The method according to claim 18 wherein the electronic second-regulating is fail-safe in respect of each of the electronic first-regulating, the first-generating, and the second-generating.

20. The method according to claim 13 wherein the second-generating is fail-safe in respect of at least one of
the electronic first-regulating, meaning that the second-generating continues even should, by failure or otherwise, the master electronic voltage regulator fail in its electronic first-regulating of the associated first one of the plurality of electrical alternators, and
the first-generating, meaning that the second-generating continues even should, by failure or by lack of motive drive or otherwise, the first one of the plurality of electrical alternators fail to produce electrical power into the load.

21. The method according to claim 20 wherein the second-generating is fail-safe in respect of each of the electronically first-regulating and the first-generating.

22. A power system for producing electrical power from a source of motive power comprising:
a battery;
a plurality of alternators connected in electrical parallel across the battery, each alternator being individually responsive to an individually associated regulating signal to produce electrical power from the source of motive power; and
a plurality of identical Frequency-on-Demand electronic voltage regulators each producing an associated pulse-position-modulated signal for regulating an associated one of the plurality of alternators, the plurality of electronic voltage regulators connected by a single wire so that
a one of the plurality of electronic voltage regulators having a lowest voltage target will turn “ON” the pulse-position-modulated signal output from all the plurality of electronic voltage regulators, while
a one of the plurality of electronic voltage regulators producing a pulse-position-modulated signal having the longest “OFF” time will turn “OFF” the pulse-position-modulated signal output from all the electronic voltage regulators;
wherein the single wire serves to synchronize all pairs of electronic voltage regulators and associated alternators.
